(19) United States
(12) Patent Application Publication
(10) Pub. No.: US 2020/0254847 A1
(43) Pub. Date: Aug. 13, 2020

(54) IN-VEHICLE AIR CONDITIONING DEVICE AND CONTROL METHOD FOR IN-VEHICLE AIR CONDITIONING DEVICE

(71) Applicant: MITSUBISHI HEAVY INDUSTRIES, LTD., Tokyo (JP)

(72) Inventors: Masahiro NAKAMURA, Tokyo (JP); Hideyuki MINAI, Tokyo (JP); Makoto TAKEUCHI, Tokyo (JP); Ayako IINO, Tokyo (JP); Yo AKIYAMA, Tokyo (JP)

(21) Appl. No.: 16/675,952

(22) Filed: Nov. 6, 2019

(30) Foreign Application Priority Data
Feb. 13, 2019 (JP) 2019-023407

(51) Int. Cl. B60H 1/00; B60H 1/24; B60H 1/34

(52) U.S. Cl. CPC B60H 1/00842; B60H 1/3407; B60H 1/246; B60H 1/245

(57) ABSTRACT

An in-vehicle air conditioning device includes a plurality of air conditioning openings provided for each of a plurality of seats of the vehicle at at least one of an upper part and a lower part of the vehicle corresponding to each seat; a plurality of airflow generators that are provided for each of the air conditioning openings and generate an airflow discharged from the air conditioning openings while controlling a temperature and an amount of the airflow; and a controller that individually controls the plurality of airflow generators, wherein at least some of the plurality of airflow generators include an air volume distribution adjustor adjusts planar distribution of a volume of air that passes through the air volume distribution adjustor, and wherein the controller control an amount of the planar distribution of the volume of air adjusted by the air volume distribution adjustor.

### TECHNICAL FIELD

The present invention relates to an in-vehicle air conditioning device and a control method for an in-vehicle air conditioning device. Priority is claimed on Japanese Patent Application No. 2019-023407, filed Feb. 13, 2019, the content of which is incorporated herein by reference.

### BACKGROUND ART

People feel heat and cold at different levels, and thus there are cases in which an atmosphere of the same temperature can feel pleasant to some and unpleasant to others. Particularly, in terms of cars, car sharing that is an increasing practice in car use in which many and unspecified people share one car has begun to become widespread in recent years, and therefore individual control over car air conditioning is expected to be more necessary in the future. Although there are currently air conditioning systems such as a dual air conditioner that can be operated by individual occupants in front seats, the system basically controls the atmosphere with temperature-adjusted wind blowing from a fixed air conditioning opening, and the operation range of wind directions is limited. In a case where parts of the body have different temperatures due to the influence of an outside environment such as exposure to sunlight, it is difficult for an individual to make a desired air-conditioned environment. Particularly, the number of air conditioning openings for rear seats is limited in most cases, and it is more difficult for individuals to control an air conditioning environment as they desire.

Patent Literature 1 discloses an in-vehicle air conditioning device that independently controls air conditioning of individual zones by dividing a car interior into four zones on the front, rear, left and right sides. The in-vehicle air conditioning device described in Patent Literature 1 includes an air conditioning unit for the front seats and an air conditioning unit for the rear seats. Each of the air conditioning unit for the front seats and the air conditioning unit for the rear seats includes a centrifugal blower that generates an airflow, a cooling heat exchanger that cools the airflow generated by the centrifugal blower, a partition board that divides the airflow cooled through the cooling heat exchanger into a left airflow and a right airflow, a heating heat exchanger, a left door for adjusting an amount of the left airflow divided by the partitioning board that passes through the heating heat exchanger, a right door for adjusting an amount of the right airflow divided by the partitioning board that passes through the heating heat exchanger, a left outlet, a right outlet, an opening/closing door of the left outlet, and an opening/closing door of the right outlet.

### CITATION LIST

### Patent Literature

### PATENT LITERATURES

[Patent Literature 1] Japanese Unexamined Patent Application, First Publication No. 2005-297903

### SUMMARY OF INVENTION

### Technical Problem

In the in-vehicle air conditioning device described in Patent Literature 1, the airflow generated by the one centrifugal blower is separated into the left airflow and the right airflow by the partitioning board, temperatures of the airflows are individually adjusted, and the airflows are discharged from the left outlet and the right outlet. Thus, in a case where the temperatures set for the left and right airflows are significantly different, for example, the volume of air becomes excessively high or low, and thus there is a problem that the temperatures for the left and right airflows sometimes are not properly controlled at the same time.

The present invention takes the above-described circumstances into consideration, and aims to provide an in-vehicle air conditioning device and a control method for an in-vehicle air conditioning device that enable to adjust temperatures for individual occupants more appropriately.

### Solution to Problem

To solve the above-described problems, an aspect of the present invention is an in-vehicle air conditioning device which is an air conditioning device mounted in a vehicle, and includes a plurality of air conditioning openings provided for each of a plurality of seats of the vehicle at at least one of an upper part and a lower part of the vehicle corresponding to each of the seats, a plurality of airflow generators that are provided for each of the air conditioning openings and configured to generate an airflow discharged from the air conditioning openings while controlling a temperature and an amount of the airflow, and a controller configured to individually control the plurality of airflow generators.

In addition, another aspect of the present invention is an in-vehicle air conditioning device which is an air conditioning device mounted in a vehicle, and includes a plurality of air conditioning openings provided for each of a plurality of seats of the vehicle at at least one of an upper part and a lower part of the vehicle corresponding to each of the seats, a plurality of airflow generators that are provided for each of the air conditioning openings and configured to generate an airflow discharged from the air conditioning openings while controlling a temperature and an amount of the airflow, and a controller configured to individually control the plurality of airflow generators, in which at least some of the plurality of airflow generators include an air volume distribution adjustor configured to that adjusts planar distribution of a volume of air that passes through the air volume distribution adjustor, and in which the controller is configured to controls an amount of the planar distribution of the volume of air adjusted by the air volume distribution adjustor.

In addition, another aspect of the present invention is the in-vehicle air conditioning device in which the plurality of air conditioning openings are provided for each of the plurality of seats of the vehicle at both the upper part and the lower part of the vehicle corresponding to the seat, each of the plurality of airflow generators has an axial blower configured to generate the airflow, and the controller is configured to control a rotation direction of each of the axial blowers such that the airflow is discharged from one part of the upper part and the lower part corresponding to the seat and then sucked in at the other part.

In addition, another aspect of the present invention is the in-vehicle air conditioning device in which at least some of the plurality of airflow generators include an air volume distribution adjustor configured to adjust planar distribution of a volume of air that passes through the air volume distribution adjustor, and the controller is configured to control an amount of the planar distribution of the volume of air adjusted by the air volume distribution adjustor.

In addition, another aspect of the present invention is the in-vehicle air conditioning device in which the controller is configured to control the air volume distribution adjustor corresponding to each seat according to a detection result of temperature distribution corresponding to the seat.

In addition, another aspect of the present invention is the in-vehicle air conditioning device in which the controller is configured to control the air volume distribution adjustor corresponding to each seat according to a detection result of a solar sensor corresponding to the seat.

In addition, another aspect of the present invention is the in-vehicle air conditioning device in which the controller is configured to control the air volume distribution adjustor such that a volume of air at an end part of the air volume distribution adjustor is higher than a volume of air at a center part of the air volume distribution adjustor.

In addition, another aspect of the present invention is the in-vehicle air conditioning device in which the plurality of air conditioning openings are provided for each of the plurality of seats of the vehicle at both the upper part and the lower part of the vehicle corresponding to the seat, in which each of the plurality of airflow generators has an axial blower configured to generate the airflow, and in which the controller is configured to control a rotation direction of each of the axial blowers such that the airflow is discharged from one part of the upper part and the lower part corresponding to the seat and then sucked in at the other part.

In addition, another aspect of the present invention is a control method for an in-vehicle air conditioning device which is a control method for an air conditioning device mounted in a vehicle, the method using a plurality of air conditioning openings that are provided for each of a plurality of seats of the vehicle at at least one of an upper part and a lower part of the vehicle corresponding to each of the seats and a plurality of airflow generators that are provided for each of the air conditioning openings and configured to generate an airflow discharged from the air conditioning openings while controlling a temperature and an amount of the airflow, in which a controller individually controls the plurality of airflow generators.

In addition, another aspect of the present invention is the in-vehicle air conditioning device in which the device further including openable and closable slits for air curtains.

### Advantageous Effects of Invention

According to the aspects of the present invention, the air conditioning openings are provided for each seat and the airflow generators that generate an airflow discharged from the air conditioning openings while controlling a temperature and an amount thereof are provided for each of the air conditioning openings, and therefore temperature adjustment for individual occupants can be performed more appropriately.

### BRIEF DESCRIPTION OF DRAWINGS

FIG. 1 is a schematic view illustrating a configuration example of a first embodiment of the present invention.

FIG. 2A is a schematic view illustrating a configuration example of the first embodiment of the present invention.

FIG. 2B is a schematic view illustrating a configuration example of the first embodiment of the present invention.

FIG. 3 is a schematic view illustrating a configuration example of a second embodiment of the present invention.

FIG. 4A is a schematic view illustrating a configuration example of the second embodiment of the present invention.

FIG. 4B is a schematic view illustrating a configuration example of the second embodiment of the present invention.

FIG. 5A is a schematic view illustrating a configuration example of an air volume distribution adjustor 3 illustrated in FIG. 4A.

FIG. 5B is a schematic view illustrating a configuration example of the air volume distribution adjustor 3 illustrated in FIG. 4A.

FIG. 5C is a schematic view illustrating a configuration example of the air volume distribution adjustor 3 illustrated in FIG. 4A.

FIG. 5D is a schematic view illustrating a configuration example of the air volume distribution adjustor 3 illustrated in FIG. 4A.

FIG. 6A is a schematic view illustrating a configuration example of a third embodiment of the present invention.

FIG. 6B is a schematic view illustrating a configuration example of the third embodiment of the present invention.

FIG. 7 is a block diagram illustrating a configuration example of the third embodiment of the present invention.

FIG. 8 is a flowchart showing an operation example of the third embodiment of the present invention.

FIG. 9 is a schematic block diagram illustrating a configuration of a computer according to at least one of the embodiments.

FIG. 10 is a schematic view illustrating a configuration example of an embodiment of the present invention.

### DESCRIPTION OF EMBODIMENTS

Embodiments of the present invention will be described below with reference to the drawings. Further, the same reference numerals will be used for the same or equivalent configurations in the drawings and repeated description will be appropriately omitted.

### First Embodiment

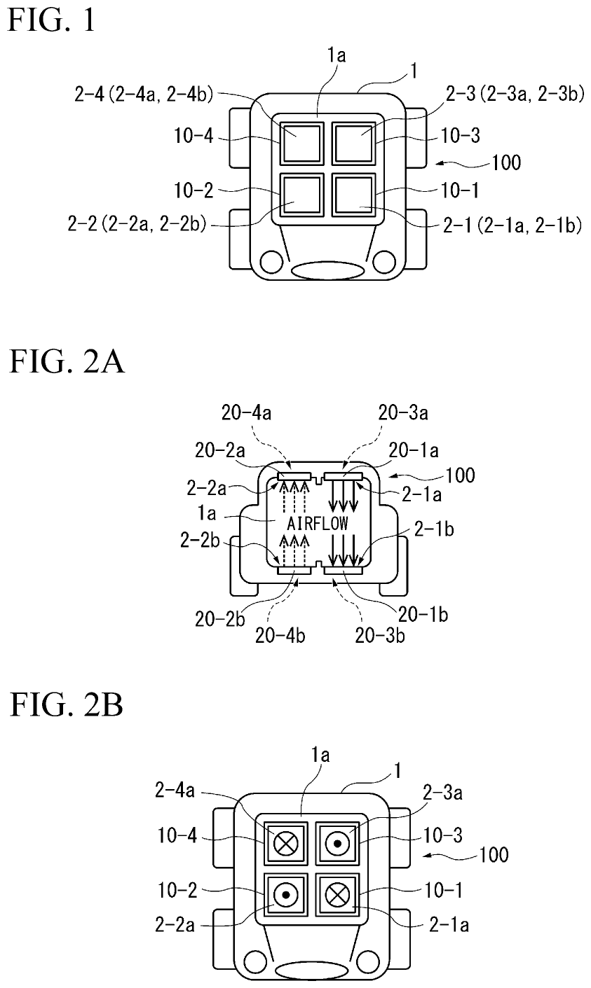

FIG. 1 is a schematic view illustrating a basic configuration example of a first embodiment of an in-vehicle air conditioning device of the present invention. FIG. 1 schematically illustrates an arrangement example of air conditioning openings 2-1, 2-2, 2-3, and 2-4 included in an in-vehicle air conditioning device 100 in a car interior 1a of a passenger car 1 (vehicle) viewed from above. The in-vehicle air conditioning device 100 of the first embodiment of the present invention illustrated in FIG. 1 is an air conditioning device mounted in the passenger car 1 and has a plurality of air conditioning openings 2-1, 2-2, 2-3, and 2-4 for each of a plurality of seats 10-1, 10-2, 10-3, and 10-4 of the passenger car 1, the openings being provided on at least one of an upper part (ceiling) and a lower part (floor) corresponding to the seats 10-1, 10-2, 10-3, and 10-4. The air conditioning openings 2-1 to 2-4 are outlets or inlets of airflows whose temperature is controlled by the in-vehicle air conditioning device 100. Further, the air conditioning opening 2-1 illustrated in FIG. 1 includes at least one of an air conditioning opening 2-1a on the upper part and an air conditioning opening 2-1b on the lower part illustrated in FIG. 2A. The air conditioning opening 2-2 illustrated in FIG. 1 includes at least one of an air conditioning opening 2-2a on the upper part and an air conditioning opening 2-2b on the lower part illustrated in FIG. 2A. The air conditioning opening 2-3 illustrated in FIG. 1 includes at least one of an air conditioning opening 2-3a on the upper part illustrated in FIG. 2B and an air conditioning opening 2-3b on the lower part that is not illustrated in FIGS. 2A and 2B. The air conditioning opening 2-4 illustrated in FIG. 1 includes at least one of an air conditioning opening 2-4a on the upper part illustrated in FIG. 2B and an air conditioning opening 2-4b on the lower part that is not illustrated in FIGS. 2A and 2B. In addition, the air conditioning openings 2-1 to 2-4 (2-1a and 2-1b to 2-4a and 2-4b) will also be collectively referred to as air conditioning openings 2 below.

FIGS. 2A and 2B are schematic views illustrating arrangement examples in which the in-vehicle air conditioning device 100 illustrated in FIG. 1 includes the eight air conditioning openings 2-1a, 2-1b, 2-2a, 2-2b, 2-3a, 2-3b, 2-4a, and 2-4b (however, the air conditioning openings 2-3b and 2-4b on the lower part are not illustrated in FIGS. 2A and 2B). FIG. 2A is a cross-sectional view of the car interior 1a from the front of the passenger car 1, and FIG. 2B is a plan view illustrating a direction of an airflow of each of the air conditioning openings 2 with Xs and circles. In the examples illustrated in FIGS. 2A and 2B, the in-vehicle air conditioning device 100 includes a plurality of airflow generators 20-1a, 20-1b, 20-2a, 20-2b, 20-3a, 20-3b, 20-4a, and 20-4b which are provided for the air conditioning openings 2-1a, 2-1b, 2-2a, 2-2b, 2-3a, 2-3b, 2-4a, and 2-4b, respectively, and generate airflows discharged from the air conditioning openings 2-1a, 2-1b, 2-2a, 2-2b, 2-3a, 2-3b, 2-4a, and 2-4b while controlling a temperature and an amount thereof. Further, the airflow generators 20-1a, 20-1b, 20-2a, 20-2b, 20-3a, 20-3b, 20-4a, and 20-4b will also be collectively referred to as airflow generators 20.

Each airflow generator 20 has an axial blower, a cooling heat exchanger, and a heating heat exchanger, and cools an airflow generated by the axial blower with the cooling heat exchanger and heats some or all of the cooled airflow with the heating heat exchanger, and then discharges the airflow from the air conditioning openings 2. The cooling heat exchanger is an evaporator, a carburetor, or the like and constitutes a refrigeration cycle together with a compressor, a condenser, a receiver, an expansion valve, which are not illustrated, or the like using a refrigerant. The heating heat exchanger heats air using cooling water of the engine as a heat source. The axial blower has a motor and a propeller and generates an airflow in the axial direction of the propeller to flow in a discharge direction or a suction direction of the air conditioning opening 2 according to the rotation direction of the motor. However, in a case where a direction of airflows generated from the airflow generators 20 is set only to a discharge direction, the axial blower may be replaced with a centrifugal blower. Further, in the present embodiment, the term “axial blower” is assumed to include an axial blower and an axial flow compressor. In addition, the airflow generators 20 have a plurality of temperature sensors therein and control a volume and a temperature of airflows discharged from the air conditioning openings 2 by adjusting, for example, a volume of an airflow generated by the axial blower and a volume of an airflow heated by the heating heat exchanger with a control device (controller) included in the in-vehicle air conditioning device 100, which is not illustrated. Each of the airflow generators 20 operates in a state in which the axial blower is rotated (ON state) or a state in which the axial blower is stopped (OFF state). Further, in a case where the airflow generators 20 operate in a direction in which airflows are sucked from the air conditioning openings 2, for example, the airflow generators 20 can limit cooling or heating of the sucked air by limiting an amount of refrigerant supplied to the cooling heat exchanger or an amount of hot water (heat medium) supplied to the heating heat exchanger or using a bypass flow path which is provided to be openable and closable from the air conditioning openings 2 to the axial blower without passing through the cooling heat exchanger or the heating heat exchanger to avoid cooling or heating.

In the in-vehicle air conditioning device 100 illustrated in FIGS. 2A and 2B, the plurality of air conditioning openings 2-1a, 2-1b, 2-2a, 2-2b, 2-3a, 2-3b, 2-4a, and 2-4b are provided on both of the upper part and the lower part corresponding to the seats 10-1 to 10-4 for each of the plurality of seats 10-1 to 10-4 of the passenger car 1. In this case, the air conditioning opening 2-1a is provided at the upper part of the seat 10-1, and the air conditioning opening 2-1b is provided at the lower part of the seat 10-1. Likewise, the air conditioning opening 2-2a is provided at the upper part of the seat 10-2, and the air conditioning opening 2-2b is provided at the lower part of the seat 10-2. The air conditioning opening 2-3a is provided at the upper part of the seat 10-3, and the air conditioning opening 2-3b is provided at the lower part of the seat 10-3. The air conditioning opening 2-4a is provided at the upper part of the seat 10-4, and the air conditioning opening 2-4b is provided at the lower part of the seat 10-4.

In the in-vehicle air conditioning device 100 illustrated in FIGS. 2A and 2B, at the time of heating (air conditioning control for heating the air), the direction of the airflow is controlled in the direction from the bottom to the top as indicated by the dashed-line arrows using the air conditioning opening 2-2b at the lower part as a discharge side and the air conditioning opening 2-2a at the upper part as a suction side as illustrated in FIGS. 2A and 2B. In addition, at the time of cooling (air conditioning control for cooling the air) in the in-vehicle air conditioning device 100 illustrated in FIGS. 2A and 2B, the direction of the airflow is controlled in the direction from the top to the bottom as indicated by the solid-line arrows using the air conditioning opening 2-1a at the upper part as a discharge side and the air conditioning opening 2-1b at the lower part as a suction side as illustrated in FIG. 2A. Each of the airflow generators 20 is independently controlled by the control device, which is not illustrated, and the air conditioning opening 2-3a at the upper part can be set as a suction side (and the air conditioning opening 2-3b at the lower part facing the aforementioned opening set as a discharge side) or the air conditioning opening 2-4a at the upper part can be set as a discharge side (and the air conditioning opening 2-4b at the lower part facing the aforementioned opening set as a suction side), for example, as illustrated in FIG. 2B.

As described above, the in-vehicle air conditioning device 100 illustrated in FIGS. 1, 2A, and 2B includes the plurality of air conditioning openings 2-1 to 2-4 provided at at least one of the upper part and the lower part corresponding to the seats 10-1 to 10-4 for each of the plurality of seats 10-1 to 10-4, and the plurality of airflow generators 20 which are provided for each of the air conditioning openings 2-1 to 2-4 and generate airflows discharged from the air conditioning openings 2-1 to 2-4 while controlling a temperature and an amount thereof. Since the configuration is based on the premise that the seats are set in the car interior 1a of the passenger car 1 and there is an occupant in each seat, by providing the air conditioning opening at at least one of the upper part and the lower part corresponding to each seat, the coverage of an airflow discharged from the air conditioning opening can be set as an individual air conditioning area corresponding to the occupant (occupants are assumed to include crew members and passengers in the present embodiment). In addition, by performing air-conditioning with a unidirectional airflow from the lower part (floor) to the upper part (ceiling) or from the upper part (ceiling) to the lower part (floor) in each individual air conditioning area in temperature adjustment control of the in-vehicle air conditioning device 100 as illustrated in FIGS. 2A and 2B, air conditioning corresponding to the preference is possible for each area without mixing of the unidirectional airflow with air conditioning of another area. At this moment, the temperature is adjusted by performing control over the airflow from the ceiling to the floor in the case of cooling, and control over the airflow from the floor to the ceiling in the case of heating. In addition, the accuracy of the individual air conditioning can be enhanced by causing the axial blower on the side which is not used to perform a suction operation.

### Second Embodiment

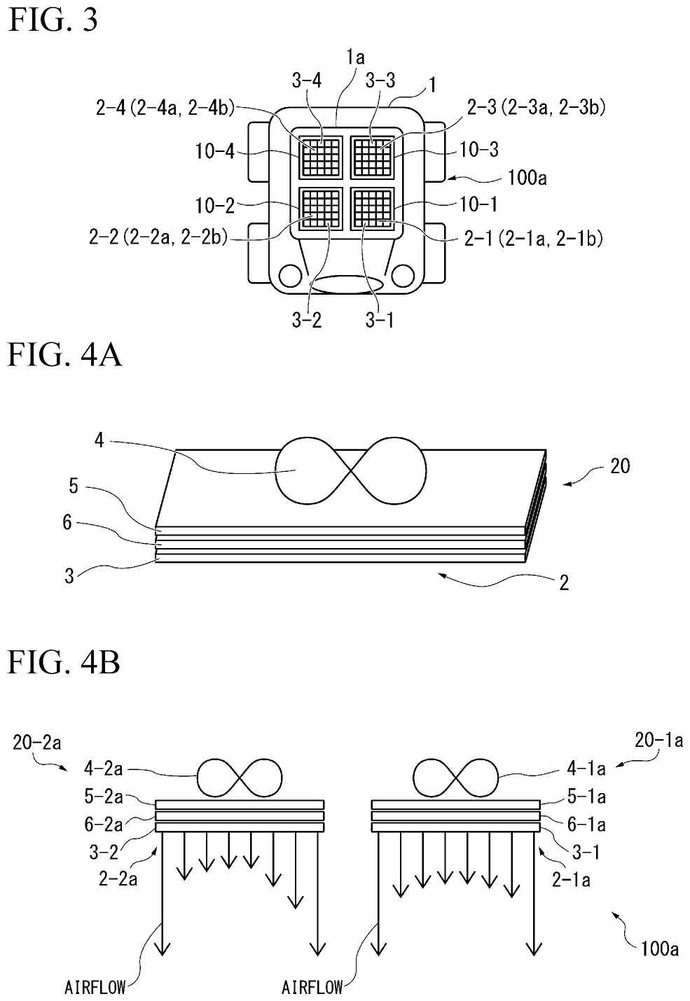

Next, a second embodiment of the present invention will be described with reference to FIGS. 3, 4A, and 4B. FIG. 3 schematically illustrates an arrangement example of air conditioning openings 2-1, 2-2, 2-3, and 2-4 of an in-vehicle air conditioning device 100a in the car interior 1a of the passenger car 1 viewed from above. FIGS. 4A and 4B are schematic views illustrating a configuration example of airflow generators 20 of the second embodiment provided for each of the air conditioning openings 2-1, 2-2, 2-3, and 2-4 illustrated in FIG. 3. FIG. 4A is a schematic view illustrating a configuration example of an airflow generator 20, and FIG. 4B is a schematic view illustrating an operation example of airflow generators 20 illustrated in FIG. 4A. The in-vehicle air conditioning device 100a of the second embodiment illustrated in FIG. 3 has a configuration corresponding to the in-vehicle air conditioning device 100 of the first embodiment illustrated in FIG. 1, and part of the configuration of the airflow generators 20 is different from that of the first embodiment.

The airflow generator 20 of the second embodiment includes an axial blower 4, a cooling heat exchanger 5, a heating heat exchanger 6, and an air volume distribution adjustor 3 in a stacked form as illustrated in FIG. 4A. In this case, the cooling heat exchanger 5 and the heating heat exchanger 6 control the capacity of heat exchange and control a temperature of an airflow by changing, for example, an amount of a refrigerant and a heat medium. However, the airflow generator 20 is not limited to the configuration in which the cooling heat exchanger 5 and the heating heat exchanger 6 are stacked, and may have a configuration in which a temperature of an airflow can be controlled by changing a volume of the airflow passing through the heating heat exchanger 6.

The air volume distribution adjustor 3 is a constituent element that electrically adjusts planar distribution of a volume of air that passes therethrough. The air volume distribution adjustor 3 can be a plate having through holes in each of regions formed by partitioning the air conditioning openings 2-1 to 2-4 in a grid shape and having opening/closing parts for each of the through holes (or each of groups obtained by dividing the through holes into a plurality of groups) that open and close the through holes, for example, as illustrated as air volume distribution adjustors 3-1 to 3-4 in FIG. 3. Each of the opening/closing parts can be constituted by, for example, a movement part that changes a degree of opening of the through hole according to change in a position or a rotation angle and a drive part that drives the movement part such as a motor.

The air volume distribution adjustors 3 can change a volume of air in each of the regions, for example, as illustrated in FIG. 4B. FIG. 4B is a front view schematically illustrating an example of distribution of airflows discharged from an air conditioning opening 2-1a and an air conditioning opening 2-2a by the airflow generator 20-1a corresponding to the air conditioning opening 2-1 and the airflow generator 20-2a corresponding to the air conditioning opening 2-2 illustrated in FIG. 3. In addition, in FIG. 4B, the length of each arrow indicates intensity of the airflow. In the example illustrated in FIG. 4B, the airflow generator 20-1a corresponding to the air conditioning opening 2-1a includes an axial blower 4-1a, a cooling heat exchanger 5-1a, a heating heat exchanger 6-1a, and the air volume distribution adjustor 3-1. In addition, the airflow generator 20-2a corresponding to the air conditioning opening 2-2a includes an axial blower 4-2a, a cooling heat exchanger 5-2a, a heating heat exchanger 6-2a, and the air volume distribution adjustor 3-2. In the example illustrated in FIG. 4B, the air volume distribution adjustor 3-1 and the air volume distribution adjustor 3-2 adjust volumes of air such that volumes of air at the left end part and the right end part are high and a volume of air of the center part is low. In addition, at the center part, the air volume distribution adjustor 3-2 adjusts a volume of air on the right side to be higher than that on the left side. In the example illustrated in FIG. 4B, air with a high volume at the end parts can be used as an air curtain. In addition, by changing the volume of air at the center part, for example, the right or left half of the body of the occupant can be subjected to intensive air conditioning.

Further, distribution control of a volume of air can be performed based on detection results that are obtained by, for example, installing a thermal sensor for each of the air conditioning openings 2-1 to 2-4 and detecting presence of an occupant and temperature distribution of each part of the occupant using the thermal sensor. For the thermal sensor, for example, a multi-pixel thermopile infrared array sensor, or the like can be used.

In addition, although the axial blower 4, the cooling heat exchanger 5, the heating heat exchanger 6, and the air volume distribution adjustor 3 are stacked in that order in the example illustrated in FIG. 4A, the order of stacking may be changed, such as providing the air volume distribution adjustor 3 between the axial blower 4 and the cooling heat exchanger 5, or the like, rather than on the air conditioning opening 2 side.

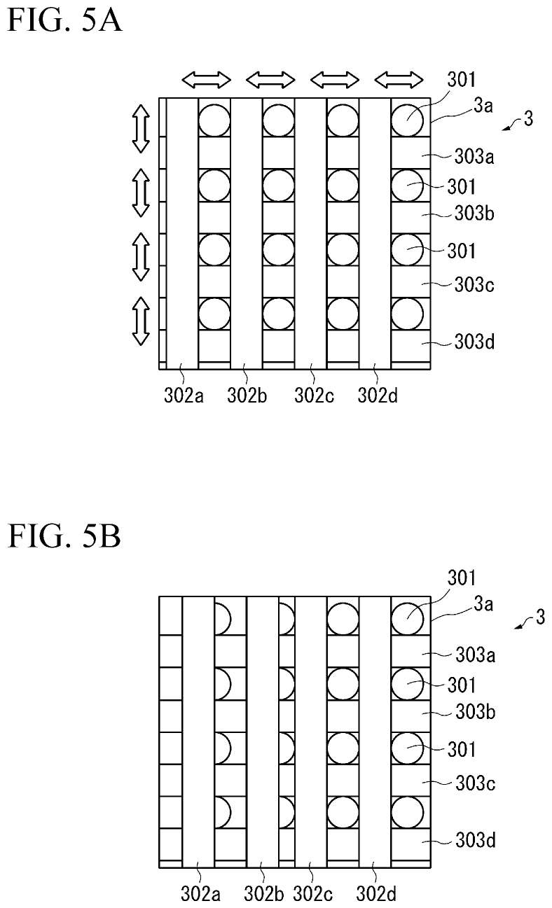

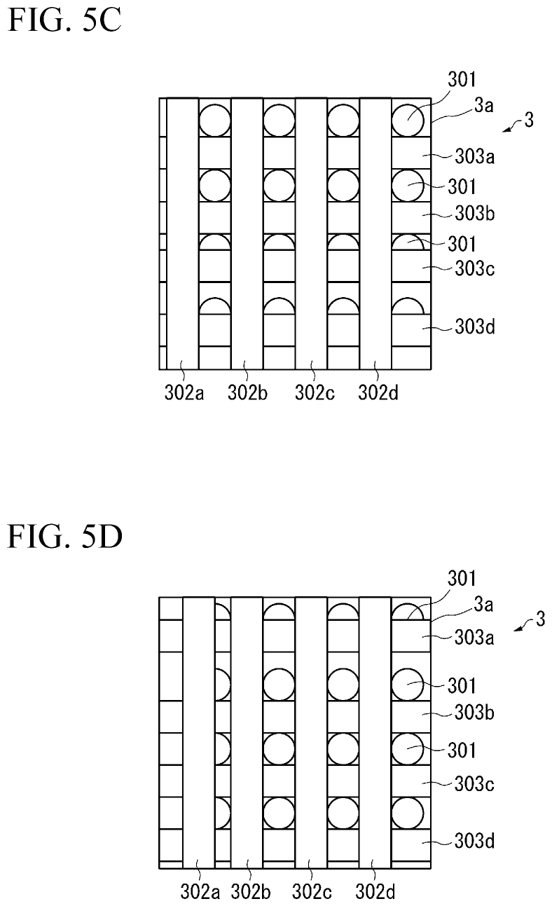

FIGS. 5A to 5D are schematic views illustrating configuration examples of the air volume distribution adjustor 3. FIG. 5A is a plan view schematically illustrating a configuration example of the air volume distribution adjustor 3, and FIGS. 5B to 5D schematically illustrate examples of different operation states of the air volume distribution adjustor 3 illustrated in FIG. 5A. In the example illustrated in FIG. 5A, the air volume distribution adjustor 3 has a flat plate 3a on which a plurality of through holes 301 are horizontally and vertically arrayed, band-shaped moving plates 302a to 302d and moving plates 303a to 303d. Each of the moving plates 302a to 302d is independently moved by a drive unit, which is not illustrated, along a guide, which is not illustrated, in the left-right direction (when facing the figures) indicated by the horizontal white arrows. Each of the moving plates 303a to 303d is independently moved by the drive unit, which is not illustrated, along a guide, which is not illustrated, in the top-bottom direction (when facing the figures) indicated by the vertical white arrows. FIG. 5B illustrates an example in which the two moving plates 302a and 302b have moved to the right. In this case, a volume of air passing through the air volume distribution adjustor 3 is large on the right side and small on the left side. FIG. 5C illustrates an example in which the two moving plates 303c and 303d have moved upward. In this case, a volume of air passing through the air volume distribution adjustor 3 is large on the upper side and small on the lower side. FIG. 5D illustrates an example in which the moving plate 302a has moved to the right and the moving plate 303a has moved upward. In this case, a volume of air passing through the air volume distribution adjustor 3 is small on the upper and left sides and large on the lower right side.

In the in-vehicle air conditioning device 100a of the second embodiment, a volume of air proper for temperature distribution of each part of an occupant can be provided by, for example, causing temperature-controlled wind coming from the floor or the ceiling to pass through the air volume distribution adjustor 3 and performing control of distribution of the volume of the air as described above. In other words, while temperature control is performed for macro areas by the in-vehicle air conditioning device 100 of the first embodiment, in the in-vehicle air conditioning device 100a of the second embodiment, temperatures can be controlled for further subdivided areas, for example, based on temperature distribution of each part of an occupant. In addition, in the in-vehicle air conditioning device 100a of the second embodiment, for example, a volume of air at four sides of the area boundary can be maintained high and caused to function as an air curtain, and thereby the accuracy in individual air conditioning of each area can be enhanced. In the in-vehicle air conditioning device 100a of the second embodiment, for example, temperature adjustment management according to temperature differences of each part of an occupant and temperature adjustment management for each area using an air curtain can have high accuracy. In addition, according to the in-vehicle air conditioning device 100a of the second embodiment, interference of neighboring air conditioning can be reduced more than in the in-vehicle air conditioning device 100 of the first embodiment.

### Third Embodiment

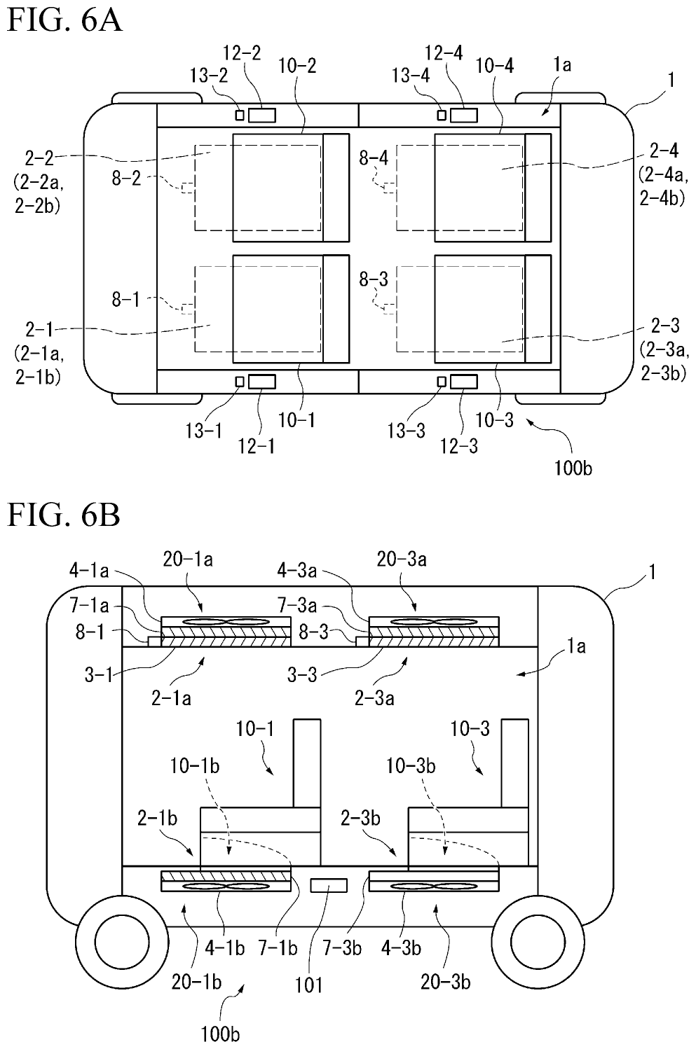

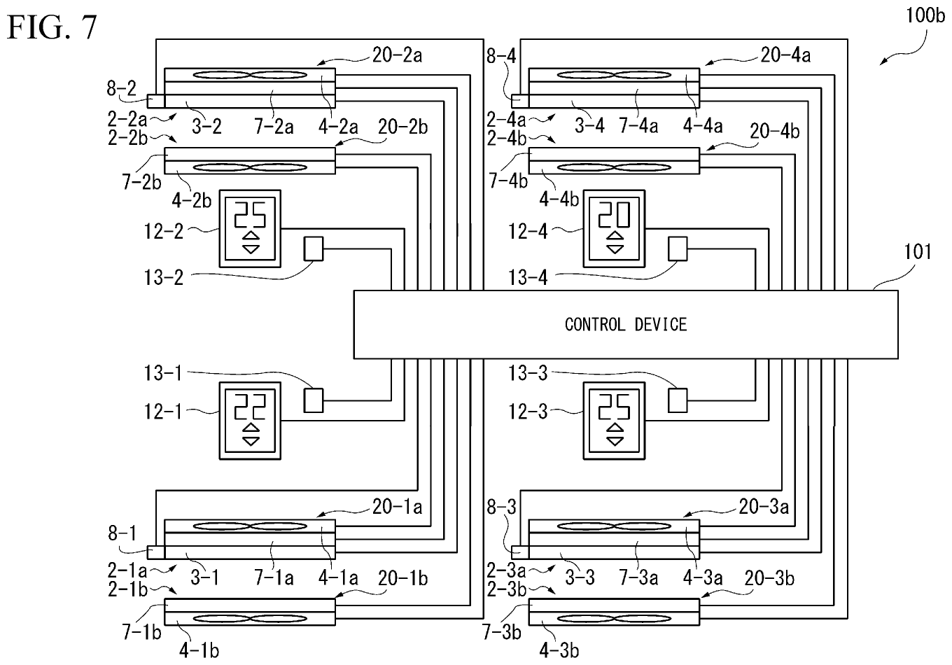

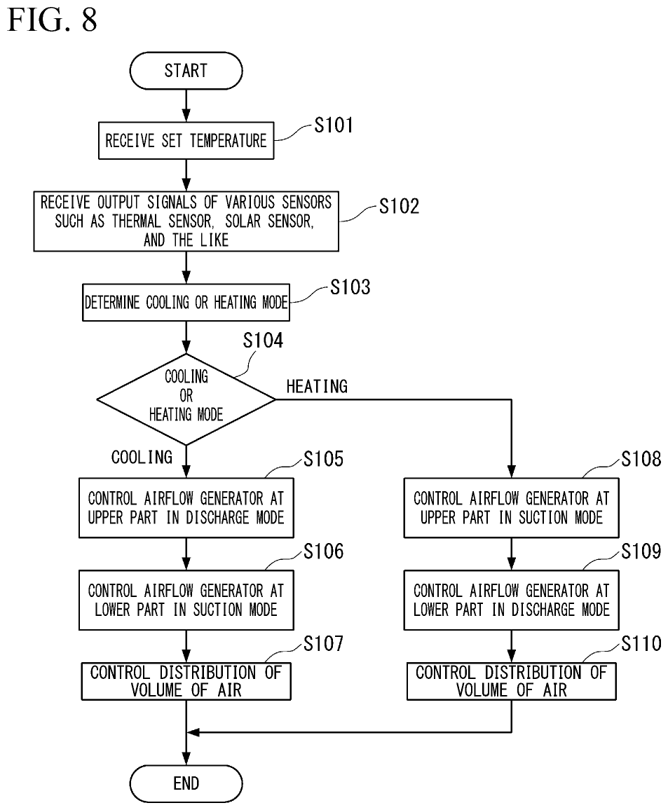

Next, a configuration example of a control system of the first and second embodiments will be described as a third embodiment of the present invention with reference to FIGS. 6A and 6B to FIG. 8. FIGS. 6A and 6B are schematic views illustrating a configuration example of the in-vehicle air conditioning device 100b of the third embodiment in the car interior 1a of the passenger car 1, FIG. 6A is a plan view schematically illustrating the car interior 1a, and FIG. 6B is a side view schematically illustrating the car interior 1a. FIG. 7 is a block diagram illustrating a configuration example of a control device 101 of the in-vehicle air conditioning device 100b illustrated in FIGS. 6A and 6B. FIG. 8 is a flowchart showing an operation example of the control device 101 of FIG. 7. The in-vehicle air conditioning device 100b of the third embodiment illustrated in FIGS. 6A and 6B corresponds to the in-vehicle air conditioning device 100 of the first embodiment illustrated in FIG. 1 and the in-vehicle air conditioning device 100a of the second embodiment illustrated in FIG. 3.

Further, in the third embodiment, the airflow generator 20-1a corresponding to the air conditioning opening 2-1a includes an axial blower 4-1a, a heat exchange unit 7-1a, and the air volume distribution adjustor 3-1 as illustrated in FIGS. 6A and 6B or FIG. 7. The heat exchange unit 7-1a includes the cooling heat exchanger 5-1a and the heating heat exchanger 6-1a illustrated in FIG. 4B, a sensor such as a temperature sensor, an actuator, and the like. In addition, the airflow generator 20-2a corresponding to the air conditioning opening 2-2a includes an axial blower 4-2a, a heat exchange unit 7-2a, and the air volume distribution adjustor 3-2. The heat exchange unit 7-2a includes the cooling heat exchanger 5-2a and the heating heat exchanger 6-2a illustrated in FIG. 4B, a sensor such as a temperature sensor, an actuator, and the like. In addition, the airflow generator 20-3a corresponding to the air conditioning opening 2-3a includes an axial blower 4-3a, a heat exchange unit 7-3a, and the air volume distribution adjustor 3-3. The heat exchange unit 7-3a includes a cooling heat exchanger, a heating heat exchanger, a sensor such as a temperature sensor, an actuator, and the like. In addition, the airflow generator 20-4a corresponding to the air conditioning opening 2-4a includes an axial blower 4-4a, a heat exchange unit 7-4a, and the air volume distribution adjustor 3-4. The heat exchange unit 7-4a includes a cooling heat exchanger, a heating heat exchanger, a sensor such as a temperature sensor, an actuator, and the like.

In addition, the airflow generator 20-1b corresponding to the air conditioning opening 2-1b includes an axial blower 4-1b and a heat exchange unit 7-1b. The heat exchange unit 7-1b includes a cooling heat exchanger, a heating heat exchanger, a sensor such as a temperature sensor, an actuator, and the like. In addition, the airflow generator 20-2b corresponding to the air conditioning opening 2-2b includes an axial blower 4-2b and a heat exchange unit 7-2b. The heat exchange unit 7-2b includes a cooling heat exchanger, a heating heat exchanger, a sensor such as a temperature sensor, an actuator, and the like. In addition, the airflow generator 20-3b corresponding to the air conditioning opening 2-3b includes an axial blower 4-3b and a heat exchange unit 7-3b. The heat exchange unit 7-3b includes a cooling heat exchanger, a heating heat exchanger, a sensor such as a temperature sensor, an actuator, and the like. In addition, the airflow generator 20-4b corresponding to the air conditioning opening 2-4b includes an axial blower 4-4b and a heat exchange unit 7-4b. The heat exchange unit 7-4b includes a cooling heat exchanger, a heating heat exchanger, a sensor such as a temperature sensor, an actuator, and the like. Further, the heat exchange units 7-1a, 7-1b, 7-2a, 7-2b, 7-3a, 7-3b, 7-4a, and 7-4b will be collectively referred to as the heat exchange units 7 below.

Further, in the third embodiment, for example, the air conditioning openings 2 at the lower part such as the air conditioning opening 2-1b and the air conditioning opening 2-3b discharge airflows to the car interior 1a or suck in the air from the car interior 1a via, for example, a duct 10-1b provided at the lower part of the seat 10-1, a duct 10-3b provided at the lower part of the seat 10-3, or the like as illustrated in FIG. 6B. In addition, in the configuration example illustrated in FIGS. 6A and 6B, and the like, although only the airflow generators 20 at the upper part among the plurality of airflow generators 20 include the air volume distribution adjustors 3, the airflow generators 20 at the lower part may include the air volume distribution adjustors 3.

In addition, the in-vehicle air conditioning device 100b of the third embodiment includes thermal sensors 8-1, 8-2, 8-3, and 8-4. The thermal sensor 8-1 is installed near the air conditioning opening 2-1a, detects temperature distribution of the spatial region corresponding to the seat 10-1 corresponding to the air conditioning opening 2-1a (the spatial region in which the seat and the occupant sitting on the seat are located), and outputs the detection result to the control device 101. The thermal sensor 8-2 is installed near the air conditioning opening 2-2a, detects temperature distribution of the spatial region corresponding to the seat 10-2 corresponding to the air conditioning opening 2-2a, and outputs the detection result to the control device 101. The thermal sensor 8-3 is installed near the air conditioning opening 2-3a, detects temperature distribution of the spatial region corresponding to the seat 10-3 corresponding to the air conditioning opening 2-3a, and outputs the detection result to the control device 101. The thermal sensor 8-4 is installed near the air conditioning opening 2-4a, detects temperature distribution of the spatial region corresponding to the seat 10-4 corresponding to the air conditioning opening 2-4a, and outputs the detection result to the control device 101.

In addition, the in-vehicle air conditioning device 100b of the third embodiment includes operation panels 12-1, 12-2, 12-3, and 12-4. The operation panel 12-1 is configured as a touch sensor panel installed near the seat 10-1, displays a current set temperature corresponding to the seat 10-1, receives an air conditioning temperature set value according to an operation of the occupant, or the like sitting on the seat 10-1, and outputs the value to the control device 101. The operation panel 12-2 is configured as a touch sensor panel installed near the seat 10-2, displays a current set temperature corresponding to the seat 10-2, receives an air conditioning temperature set value according to an operation of the occupant, or the like sitting on the seat 10-2, and outputs the value to the control device 101. The operation panel 12-3 is configured as a touch sensor panel installed near the seat 10-3, displays a current set temperature corresponding to the seat 10-3, receives an air conditioning temperature set value according to an operation of the occupant, or the like sitting on the seat 10-3, and outputs the value to the control device 101. The operation panel 12-4 is configured as a touch sensor panel installed near the seat 10-4, displays a current set temperature corresponding to the seat 10-4, receives an air conditioning temperature set value according to an operation of the occupant, or the like sitting on the seat 10-4, and outputs the value to the control device 101.

In addition, the in-vehicle air conditioning device 100b of the third embodiment includes solar sensors 13-1, 13-2, 13-3, and 13-4. The solar sensor 13-1 is installed near the seat 10-1 corresponding to the air conditioning opening 2-1a, detects an amount of solar radiation, and outputs the detection result to the control device 101. The solar sensor 13-2 is installed near the seat 10-2 corresponding to the air conditioning opening 2-2a, detects an amount of solar radiation, and outputs the detection result to the control device 101. The solar sensor 13-3 is installed near the seat 10-3 corresponding to the air conditioning opening 2-3a, detects an amount of solar radiation, and outputs the detection result to the control device 101. The solar sensor 13-4 is installed near the seat 10-4 corresponding to the air conditioning opening 2-4a, detects an amount of solar radiation, and outputs the detection result to the control device 101.

In addition, the in-vehicle air conditioning device 100b of the third embodiment includes the control device 101 illustrated in FIG. 7. The control device 101 receives signals indicating temperature set values set on the operation panels 12-1, 12-2, 12-3, and 12-4, a signal indicating the distribution of temperatures detected by the thermal sensors 8-1, 8-2, 8-3, and 8-4, signals indicating amount of solar radiation detected by the solar sensors 13-1, 13-2, 13-3, and 13-4, a signal indicating a temperature of each of parts detected by the heat exchange units 7, output signals of other various sensors, which are not illustrated, such as a temperature sensor that detects an outside temperature, and the like. In addition, the control device 101 controls each of the airflow generators 20 or controls operations of a compressor, a valve, and the like, which are not illustrated, and thereby controls such that an air conditioning temperature of the spatial region corresponding to the seat 10-1 corresponding to the air conditioning opening 2-1, an air conditioning temperature of the spatial region corresponding to the seat 10-2 corresponding to the air conditioning opening 2-2, an air conditioning temperature of the spatial region corresponding to the seat 10-3 corresponding to the air conditioning opening 2-3, and an air conditioning temperature of the spatial region corresponding to the seat 10-4 corresponding to the air conditioning opening 2-4 match the set temperatures respectively.

Next, an operation example of the control device 101 illustrated in FIG. 7 will be described with reference to FIG. 8. FIG. 8 is a flowchart showing an example of a control operation by the control device 101 executed over the pair of the airflow generator 20 at the upper part and the airflow generator 20 at the lower part. The control device 101 executes the process shown in FIG. 8 for each of the four pairs of the airflow generators 20 in a parallel manner. The process shown in FIG. 8 is repeatedly executed at predetermined intervals.

The process shown in FIG. 8 will be described below by exemplifying the pair of the airflow generator 20-1a corresponding to the air conditioning opening 2-1a and the airflow generator 20-1b corresponding to the air conditioning opening 2-1b which correspond to the seat 10-1. Further, the control device 101 executes processes related to display and reception of the operation panel 12-1 at predetermined intervals different from those of the process shown in FIG. 8 in a parallel manner.

When the process shown in FIG. 8 is started, the control device 101 first receives a temperature set on the operation panel 12-1 (Step S101). Next, the control device 101 receives output signals of various sensors including the thermal sensor 8-1, the solar sensor 13-1, and the like (Step S102). Next, the control device 101 determines an operation mode of the airflow generator 20-1a and the airflow generator 20-1b to be any of a cooling mode and a heating mode based on the value of the set temperature received in Step S101 and the output signals of the various sensors received in Step S102 (Step S103).

In the cooling mode (in case of “cooling” in Step S104), the control device 101 controls the airflow generator 20-1a at the upper part in a discharge mode (Step S105) and controls the airflow generator 20-1b at the lower part in a suction mode (Step S106). In Step S105, the control device 101 causes the axial blower 4-1a to generate an airflow in the direction in which the air is discharged from the air conditioning opening 2-1a, and the heat exchange unit 7-1a to adjust a temperature of the airflow generated by the axial blower 4-1a to a temperature according to the set temperature. In addition, in Step S106, the control device 101 causes, for example, the axial blower 4-1b to generate an airflow in the direction in which the air is sucked from the air conditioning opening 2-1b, and controls the heat exchange unit 7-1b such that the heat exchange for the sucked air is limited or stopped. However, at the time of internal air circulation, for example, the heat exchange unit 7-1b may be caused to perform an operation of cooling or heating the sucked air, together with the heat exchange unit 7-1a. Next, the control device 101 controls distribution of the airflow that passes through the air volume distribution adjustor 3-1 such that based on the detection result of the thermal sensor 8-1 and the detection result of the solar sensor 13-1 received in Step S102, for example, the temperature distribution becomes uniform (Step S107).

On the other hand, in the heating mode (in the case of “heating” in Step S104), the control device 101 controls the airflow generator 20-1a at the upper part in the suction mode (Step S108) and controls the airflow generator 20-1b at the lower part in the discharge mode (Step S109). In Step S108, the control device 101 causes, for example, the axial blower 4-1a to generate an airflow in the direction in which the air is sucked from the air conditioning opening 2-1a and controls the heat exchange unit 7-1a such that heat exchange for the sucked air is limited or stopped. However, at the time of internal air circulation, for example, even the heat exchange unit 7-1a may be caused to perform an operation of cooling or heating the sucked air, together with the heat exchange unit 7-1b. In addition, in Step S109, the control device 101 causes the axial blower 4-1b to generate an airflow in the direction in which the air is discharged from the air conditioning opening 2-1b and causes the heat exchange unit 7-1b to adjust a temperature of the airflow generated by the axial blower 4-1b to a temperature according to the set temperature. Next, the control device 101 controls distribution of the airflow that passes through the air volume distribution adjustor 3-1 based on the detection result of the thermal sensor 8-1 and the detection result of the solar sensor 13-1 received in Step S102 such that, for example, the temperature distribution becomes uniform (Step S110).

Further, in Step S107 and S110, the control device 101 can control the air volume distribution adjustor 3 such that a volume of air at the end parts of the air volume distribution adjustor 3 is higher than a volume of air at the center part. In this case, since the strong airflow at the end parts functions as an air curtain, interference between neighboring air conditioning can be further reduced.

The in-vehicle air conditioning devices 100, 100a, and 100b according to the first to the third embodiments described above are air conditioning devices mounted in vehicles, and each include a plurality of air conditioning openings 2-1 to 2-4 for each of a plurality of seats 10-1 to 10-4 of a vehicle, the air conditioning openings provided at least one of an upper part and a lower part corresponding to the seats 10-1 to 10-4, a plurality of airflow generators 20 that are provided for each of the air conditioning openings 2-1 to 2-4 and generate airflows discharged from the air conditioning openings 2-1 to 2-4 while controlling a temperature and an amount thereof, and the control device 101 (controller) that individually controls the plurality of airflow generators 20. In this configuration, since the air conditioning openings are provided for each seat, and the airflow generators that generate airflows discharged from the air conditioning openings while controlling a temperature and an amount thereof are provided for each of the air conditioning openings, the airflow generators can be individually controlled for each of the seats, and temperature adjustment by individual occupants can be more appropriately performed than in a case where the airflow generators are not provided for each of the seats.

Further, the plurality of air conditioning openings 2-1 to 2-4 can be provided for each of the plurality of seats 10-1 to 10-4 of the vehicle at both parts of the upper part and the lower part of the vehicle corresponding to the seats 10-1 to 10-4. In addition, the plurality of airflow generators 20 have the axial blowers 4 each of which generates an airflow, and the control device 101 controls a rotation direction of each of the axial blowers 4 such that the airflow is discharged from one part of the upper part and the lower part corresponding to each of the seats 10-1 to 10-4 and then sucked in at the other part. According to this configuration, a flow of air can be better concentrated on each seat for which air conditioning is controlled, and temperature adjustment by individual occupants can be more appropriately performed.

In addition, at least some of the plurality of airflow generators 20 include the air volume distribution adjustors 3 that adjust planar distribution of a volume of air that passes therethrough, and the control device 101 controls an amount of the planar distribution of the volume of air adjusted by the air volume distribution adjustor 3. At this time, the control device 101 controls, for example, the air volume distribution adjustor 3 corresponding to the seat according to the detection result of the temperature distribution corresponding to the seat. In addition, the control device 101 controls the air volume distribution adjustor corresponding to the seat according to the detection result of the solar sensor corresponding to the seat. According to this configuration, temperature adjustment by individual occupants can be more appropriately performed.

Further, the control device 101 can control the air volume distribution adjustor 3 such a volume of air at the end parts of the air volume distribution adjustor 3 is higher than a volume of air at the center part. In this configuration, since the strong airflow at the end parts functions as an air curtain, interference between neighboring air conditioning can be further reduced.

Although the embodiments of the invention have been described above with reference to the drawings, a specific configuration is not limited thereto, and a modification in the design and the like made in a scope not departing from the gist of the invention is also included therein. For example, the number of seats is not limited to four, and may be multiple. In addition, a vehicle that is subject to the present embodiments is not limited to a passenger car. In addition, the present embodiment can be applied to general transports (moving objects on which people ride) other than vehicles.

### <Computer Configuration>

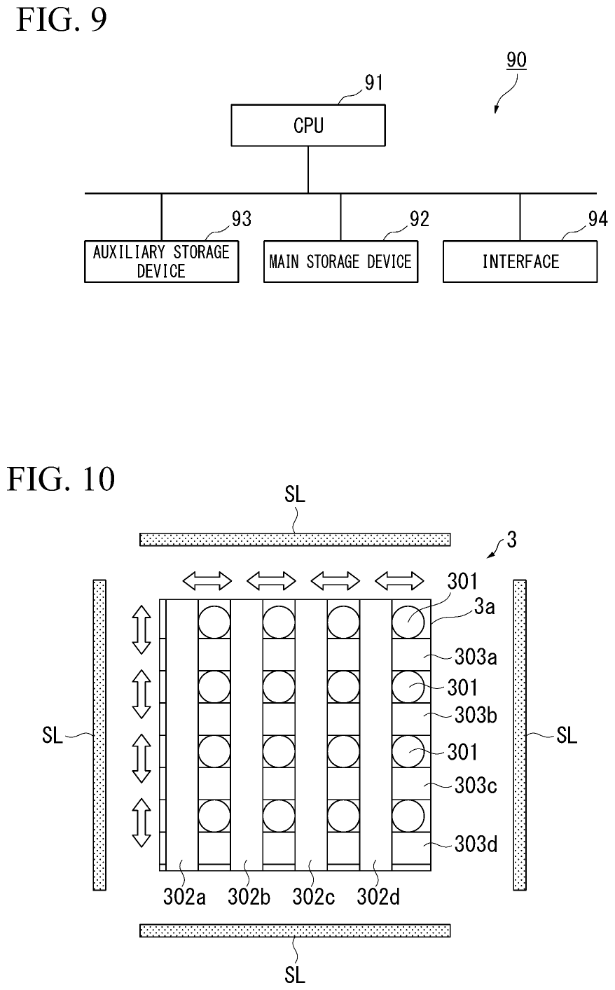

FIG. 9 is a schematic block diagram illustrating a configuration of a computer according to at least one of the embodiments.

A computer 90 includes a processor 91, a main memory 92, a storage 93, and an interface 94.

The above-described control device 101 is implemented in the computer 90. In addition, operations of each of the above-described processing units are stored in the storage 93 in the form of programs. The processor 91 reads a program from the storage 93, develops the program in the main memory 92, and executes the above-described process according to the program. In addition, the processor 91 reserves a storage area corresponding to the storage unit in the main memory 92 according to the program.

A program may be one for realizing some of functions expected to be exhibited by the computer 90. For example, a program may be exhibited by being combined with another program that is already stored in a storage or being combined with another program implemented in another device. Further, in another embodiment, the computer may include a custom large scale integrated circuit (LSI) such as a programmable logic device (PLD) in addition to or instead of the above-described configuration. Examples of the PLD include a programmable array logic (PAL), a generic array logic (GAL), a complex programmable logic device (CPLD), and a field programmable gate array (FPGA). In this case, some or all of functions realized by the processor may be realized by the integrated circuit.

Examples of the storage 93 include a hard disk drive (HDD), a solid state drive (SSD), a magnetic disk, a magneto-optical disc, a compact disc read only memory (CD-ROM), a digital versatile disc read only memory (DVD-ROM), a semiconductor memory, and the like. The storage 93 may be an internal medium that is connected directly to a bus of the computer 90, or an external medium that is connected to the computer 90 via the interface 94 or a communication line. In addition, in a case where the program is distributed to the computer 90 through communication lines, the computer 90 that has received the distribution may develop the program in the main memory 92 and cause the process to be executed. At least one of embodiments, the storage 93 is a non-transitory tangible storage medium.

FIG. 10 is a schematic view illustrating a configuration example of an embodiment of the present invention.

Openable and closable slits SL for air curtains may be provided as illustrated in FIG. 10. The slits SL may be opened and closed by a mechanism such as louvers of air conditioners or by a belt. With this configuration, more effective air curtains can be realized.

### INDUSTRIAL APPLICABILITY

According to the aspects of the present invention, the air conditioning openings are provided for each seat and the airflow generators that generate an airflow discharged from the air conditioning openings while controlling a temperature and an amount thereof are provided for each of the air conditioning openings, and therefore temperature adjustment for individual occupants can be performed more appropriately.

### REFERENCE SIGNS LIST

100, 100a, 100b In-vehicle air conditioning device
2, 2-1, 2-1a, 2-1b, 2-2, 2-2a, 2-2b, 2-3, 2-3a, 2-3b, 2-4, 2-4a, 2-4b Air conditioning opening
3, 3-1, 3-2, 3-3, 3-4 Air volume distribution adjustor
4, 4-1a, 4-1b, 4-2a, 4-2b, 4-3a, 4-3b, 4-4a, 4-4b Axial blower
5, 5-1a, 5-2a Cooling heat exchanger
6, 6-1a, 6-2a Heating heat exchanger
7-1a, 7-1b, 7-2a, 7-2b, 7-3a, 7-3b, 7-4a, 7-4b Heat exchange unit
8-1, 8-2, 8-3, 8-4 Thermal sensor
10-1, 10-2, 10-3, 10-4 Seat
SL Slit

1. An in-vehicle air conditioning device which is an air conditioning device mounted in a vehicle, the device comprising:
a plurality of air conditioning openings provided for each of a plurality of seats of the vehicle at at least one of an upper part and a lower part of the vehicle corresponding to each seat;
a plurality of airflow generators that are provided for each of the air conditioning openings and configured to generate an airflow discharged from the air conditioning openings while controlling a temperature and an amount of the airflow; and
a controller configured to individually control the plurality of airflow generators;
wherein at least some of the plurality of airflow generators include an air volume distribution adjustor configured to adjust planar distribution of a volume of air that passes through the air volume distribution adjustor, and
wherein the controller is configured to control an amount of the planar distribution of the volume of air adjusted by the air volume distribution adjustor.

2. The in-vehicle air conditioning device according to claim 1, wherein the controller is configured to control the air volume distribution adjustor corresponding to each seat according to a detection result of temperature distribution corresponding to the seat.

3. The in-vehicle air conditioning device according to claim 1, wherein the controller is configured to control the air volume distribution adjustor corresponding to each seat according to a detection result of a solar sensor corresponding to the seat.

4. The in-vehicle air conditioning device according to claim 1, wherein the controller is configured to control the air volume distribution adjustor such that a volume of air at an end part of the air volume distribution adjustor is greater than a volume of air at a center part of the air volume distribution adjustor.

5. The in-vehicle air conditioning device according to claim 1,
wherein the plurality of air conditioning openings are provided for each of the plurality of seats of the vehicle at both the upper part and the lower part of the vehicle corresponding to the seat,
wherein each of the plurality of airflow generators has an axial blower configured to generate the airflow, and
wherein the controller is configured to control a rotation direction of each of the axial blowers such that the airflow is discharged from one part of the upper part and the lower part corresponding to the seat and then sucked in at the other part.

6. A control method for an in-vehicle air conditioning device that is mounted in a vehicle, the method performed using:
a plurality of air conditioning openings that are provided for each of a plurality of seats of the vehicle at at least one of an upper part and a lower part of the vehicle corresponding to each seat; and
a plurality of airflow generators that are provided for each of the air conditioning openings and configured to generate an airflow discharged from the air conditioning openings while controlling a temperature and an amount of the airflow,
wherein a controller individually controls the plurality of airflow generators.

7. The in-vehicle air conditioning device according to claim 1,
wherein the device further comprising:
openable and closable slits for air curtains.
